(19) United States
(12) Patent Application Publication
(10) Pub. No.: US 2008/0240490 A1
(43) Pub. Date: Oct. 2, 2008

(54) SOURCE AUTHENTICATION AND USAGE TRACKING OF VIDEO

(75) Inventors: Charles A. Finkelstein, Woodinville, WA (US); Dean Rowe, Bellevue, WA (US); James E. Clarke, Redmond, WA (US); Kevin Leigh La Chapelle, Redmond, WA (US); Warren L. Burch, Redmond, WA (US); Brian Walker, Southbury, CT (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/694,829

(22) Filed: Mar. 30, 2007

(51) Int. Cl. G06K 9/00

(52) U.S. Cl. 382/100

(57) ABSTRACT

A video at a host is authenticated using a watermark in the video, wherein the watermark includes metadata related to the video, wherein authenticating the video includes comparing metadata in the watermark to unwatermarked metadata attached to the video. Watermarked host-related information is added to the video by the host.

### BACKGROUND

Authors and content owners of video wish to ensure that their copyrights are respected. However, all too often, video is illegally uploaded to video sharing sites, such as MSN® Soapbox or YouTube. These video sharing sites are at risk for legal action from the content owners. Additionally, usage terms of video posted on video sharing sites are difficult to enforce. Finally, when advertising dollars are made from the viewing of video, the content owner of the video may be entitled to compensation from the hosting service. Current video sharing systems do not help the content owners and the video sharing sites to enforce video usage terms and track viewings for distribution of revenue.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Embodiments of the invention provide source authentication and usage tracking of video. A content provider may inject a digital watermark and metadata into a video prior to uploading the video to a host (e.g., a video sharing site). The host may use the watermark to authenticate the video. The host may add host related information to the watermark for tracking postings of the video to other hosts. Content providers, viewers, and search engines may also use the watermark to authenticate the video. Embodiments of the invention may also be used for monitoring complicity with video usage rules and distribution of revenue in connection with viewings of the video.

Many of the attendant features will be more readily appreciated as the same become better understood by reference to the following detailed description considered in connection with the accompanying drawings.

### BRIEF DESCRIPTION OF THE DRAWINGS

Like reference numerals are used to designate like parts in the accompanying drawings.

FIG. 1 is a block diagram of a system in accordance with an embodiment of the invention.

FIG. 2 is a flowchart showing the logic and operations of uploading video to a host in accordance with an embodiment of the invention.

FIG. 2B is a block diagram of tracking a video in accordance with an embodiment of the invention.

FIG. 3 is a flowchart showing the logic and operations of authenticating a video in accordance with an embodiment of the invention.

FIG. 4 is a flowchart showing the logic and operations of uploading video with usage terms to a host in accordance with an embodiment of the invention.

FIG. 5 is a flowchart showing the logic and operations of verifying complicity with usage terms of a video in accordance with an embodiment of the invention.

FIG. 6 is a flowchart showing the logic and operations of uploading video with revenue sharing rules to a host in accordance with an embodiment of the invention.

FIG. 7 is a block diagram of adding watermarked host-related information to the video in accordance with an embodiment of the invention.

FIG. 8 is a block diagram of adding watermarked host-related information to the video in accordance with an embodiment of the invention.

FIG. 9 is a block diagram of adding watermarked host-related information to the video in accordance with an embodiment of the invention.

FIG. 10 is a diagram of a media player user interface in accordance with embodiment of the invention.

FIG. 11 is a block diagram of an example computing device for implementing embodiments of the invention.

### DETAILED DESCRIPTION

The detailed description provided below in connection with the appended drawings is intended as a description of the present examples and is not intended to represent the only forms in which the present examples may be constructed or utilized. The description sets forth the functions of the examples and the sequence of steps for constructing and operating the examples. However, the same or equivalent functions and sequences may be accomplished by different examples.

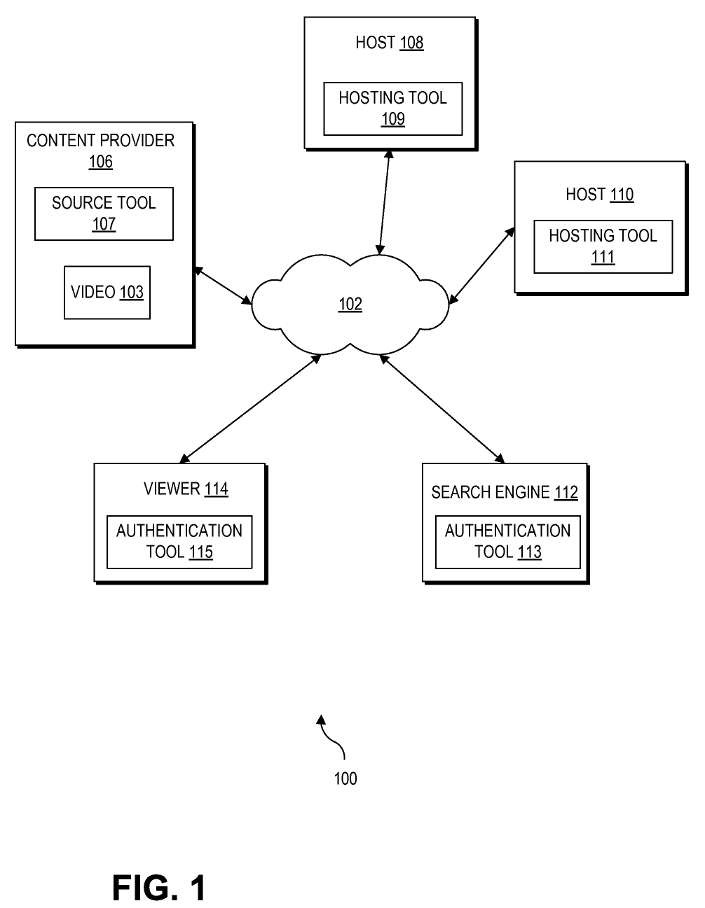

Turning to FIG. 1, a system 100 for source authentication, uploading, and usage tracking of video in accordance with an embodiment of the invention is shown. System 100 allows for a video hosting site to authenticate the source of a video received from a content provider. The content provider may inject a digital watermark and matching metadata into the video. The host may use the watermark to authenticate the video. Also, for tracking purposes, each host that posts the video adds its own watermarked host identification information. Embodiments of system 1 00 may also be used for monitoring complicity with video usage rules and distribution of revenue in connection with viewings of a video.

As used herein, “video” may or may not include an audio component recorded at the same time the video component was recorded. Also, a video may include one or more of audio tracks (such as music, voice over, sound effect, etc.), animation, graphics, still photos, transitions, or other effects that have been added to raw video footage.

While digital watermarking is well known, a short primer is provided herein. Watermarking involves placing additional information, such as identification information, into media content. Usually, the watermark is not perceptual to humans when the media content is consumed by a user. For example, the watermark is not perceptible when a watermarked video is played. The watermark includes information embedded in the media data itself and is not attached to the media, such as in a header. In video, the watermark may be placed in each frame of the video. The watermark may be placed in the video data, the audio data, or both. The information in the watermark may be secured, such as by using cryptography. The information in the watermark travels with the media content.

System 100 includes various computing devices connected by a network 102, such as the Internet. These computing devices include a content provider 106, a host 108, a host 110, a search engine 112, and a viewer 114. Content provider 106 has stored a video 103. Video 103 may be owned by a media corporation, such as a movie studio, television studio, and the like. Video 103 may also be owned (and authored) by an individual. In one example, content provider 106 includes the individual's home computer where the individual has authored and stored video 103. In another example, content provider 106 is not owned by the video's owner (e.g., video 103 is stored at network storage location leased by the owner of video 103).

Content provider 106 includes a source tool 107. Source tool 107 enables content provider 106 to watermark a video with metadata. In one embodiment, the watermark may persist when the video is transcoded. In another embodiment, the watermark may be detected from an analog copy of the video. For example, an analog copy created when video output is captured from an analog recording device, such as video tape.

Host 108 includes one or more computing devices for storing video and enabling users to view video posted to host 108. Host 108 may include a video sharing site, such as MSN® Soapbox. Host 108 may include a hosting tool 109 to authenticate a video that has been uploaded to host 108. Hosting tool 109 may verify that the watermark matches an authorized owner's identification and video metadata. Host 108 may add a searchable tag to the video metadata, a media Really Simple Syndication (RSS) tag, or other Extensible Markup Language (XML) metadata to signify that the video is authentic.

Also, for tracking, hosting tool 109 may modify the watermark with information related to host 108. This information may include host identification (ID) (such as Internet Protocol (IP) address, date/time of upload, originating IP address of the video upload, and user identification of the uploader). The host related information enables tracking of the video as the video is reposted at various hosts. For example, video 103 may be reposted to host 110 from host 108. Host 110 may use its own hosting tool 111 to authenticate video 103. Host 110 may then add its own hosting information to the video 103's watermark. In this example, the information would indicate that host 110 received video 103 from host 108.

In one embodiment, a digital signature of the video may be used to identify the owner of the video. A valid digital signature may also be used to verify that the metadata as well as the video content did not change from when the video was locked down (such as by content provider 106). Correlation of metadata and digital signature details may further increase confidence in authenticity of the video. In one embodiment, a video may be considered more likely authentic when the Uniform Resource Locator (URL) hosting the video or name of the digital signature signer is identical to the publisher name in the video metadata. For example, a video published by “Foo” and signed by “Foo” may be considered more likely authentic than a video published by “Foo” but signed by “Bar”. In another example, a video published by “Foo” and hosted at URL “Foo.com” may be considered more likely authentic than a video published by “Foo” but hosted at URL “Bar.com.”

Search engine 112 may use an authentication tool 113 to verify the authenticity of videos found as a result of a user's search. In one embodiment, the search results displayed by search engine 112 may include authenticity indicia (such as a characters, symbol, etc.) that indicate which videos shown in the search results have been authenticated. In one embodiment, search engine 112 authenticates video with authentication tool 113 as part of its web crawling process. In another embodiment, search engine 112 authenticates the video in real time when the search results are displayed to the user.

In another embodiment, search engine 112 (or an ad engine used to match ads to content) may use various evidence to rate the level of confidence that may be given to the data the search engine gathers from the video metadata (i.e., a video reliability index). The reliability index may be used internally be search engine 112 when generating search results and/or shown in search results to users. This evidence may include whether a digital signature on the video is authentic. This evidence may include whether there is a correlation between the digital signature and the publisher of the video in the video metadata. For example, a video published by “Foo” and signed by “Foo” may be considered to have more reliable metadata than a video published by “Foo” but signed by “Bar”. This evidence may include whether there is a correlation between the publisher of the video in the video metadata and the URL hosting the video. For example, a video published by “Foo” and hosted at URL “Foo.com” may be considered to have more reliable metadata than a video published by “Foo” but hosted at URL “Bar.com.”

Viewer 114 includes a computing device used to view videos, such as video 103, posted on a host, such as host 108 or host 110. Viewer 114 may include an authentication tool 115. Authentication tool 115 may authentic video being displayed on viewer 114. In one embodiment, authentication tool 115 plugs into a web browser on viewer 114. In one example, a user at viewer 114 may report inauthentic content to the host used to view the video.

Also, content provider 106 may include an authentication tool (not shown). When a content owner sees a possible unauthorized posting of video on a host, the content provider 106 may use an authentication tool to authenticate the video. If the video is inauthentic, then the path of the illegal video may be tracked using the watermark.

One skilled in the art having the benefit of this description will appreciate that components described in system 100 may be the same computing device or several computing devices operated by the same organization. For example, a user's home computer may serve as content provider 106 and viewer 114. In another example, host 108 and search engine 112 may be managed by the same corporation, for example MSN® Soapbox (a host) and Windows Live™ search (a search engine) are both managed by the Microsoft Corporation.

As described further below, embodiments of the invention may also be used as a video usage tracking system and as a video revenue sharing tracking system. The video owner may use the watermark to inject usage rules and/or revenue sharing rules into the video. Each time the video is uploaded to a new host, the new upload information is added to the watermark. The modified watermark may be read to track the path of the video. If usage rules (e.g., licensing terms) of the video are violated, then the watermarking data will show the path of the video and possibly the origin of the usage rule violation. Similarly, video tracking may be used to confirm and enforce video revenue sharing. Content providers may be entitled to rewards from a host based on the number of viewings of a video at the host.

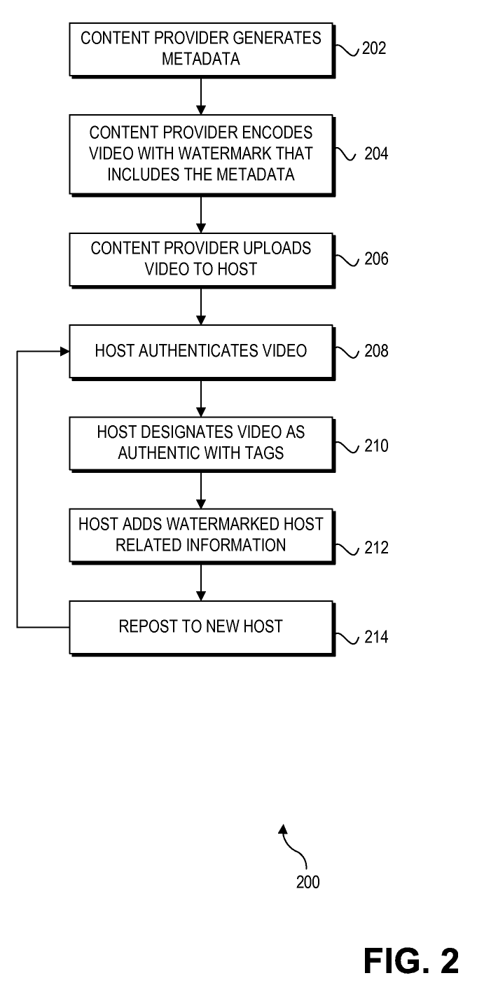

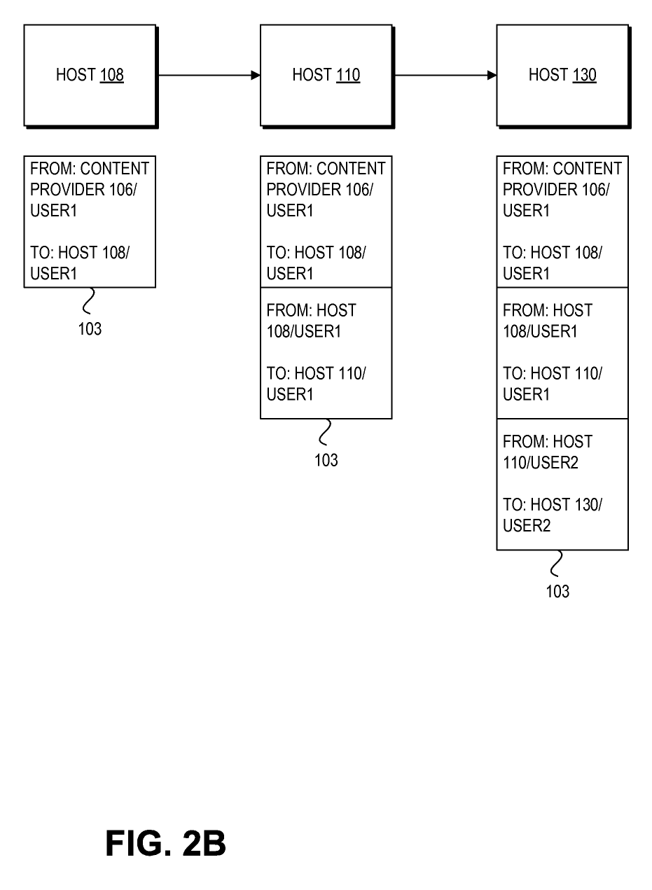

Turning to FIG. 2, a flowchart 200 shows the logic and operations of uploading a video to a host in accordance with an embodiment of the invention. Starting in block 202, a content provider generates metadata for a video. The metadata may include information associated with the video. Examples of metadata include video author, title, date created, video sharing site user identification, video duration, copyright information, and the like. In one embodiment, the metadata includes one or more elements from the Dublin Core Metadata Initiative® (e.g., contributor, coverage, creator, date, description, format, identifier, language, publisher, relation, rights, source, subject, title, and type). Video sharing site user information may include a user ID that the content owner utilizes to login to an account on the video sharing site.

Continuing to block 204, the video is encoded with a watermark that includes the metadata. Encoding the video with a watermark includes at least one of encoding only the video, encoding only the audio, encoding the video and audio, or any combination there of. The watermark may include at least a portion of the metadata. The watermarked metadata is used for authenticating the video. At least a portion of the metadata is also attached to the video unwatermarked to be used for authentication. This unsecured metadata may be attached in a video file header. Proceeding to block 206, the content provider uploads the video to the host. In one embodiment, the content owner logs in to the host site with a user ID for uploading the video. The distribution of watermarked video onto hosts and/or Peer-to-Peer (P2P) networks may be tracked via the watermark.

In an alternative embodiment, blocks 202, 204, and 206 may be conducted by a host. A video sharing site may offer services of source authentication and tracking as described herein. These services may be provided to content owners for a fee. For example, the content owner may upload a video to the host using a web browser. As part of the upload process, the content owner may provide the host with the metadata. In one embodiment, the video and the metadata may be uploaded with a secured connection. The host may then encode the video with a watermark for the content owner that shows that the content owner is the source of the video. The host may then modify the watermark with its own host information. The host may also inject the watermark with usage terms and/or revenue sharing rules for the content owner. The host may also provide usage tracking services for the content owner. For example, the content owner may login to the video sharing site (i.e., the host) and check their account for usage tracking and revenue collection information.

Next, at block 208, the host authenticates the video received from the content provider. In one embodiment, the host verifies that metadata information in the watermark matches unsecured metadata information attached to the video. This unsecured metadata may be used for other reasons, such as to be displayed when the video is played. For example, the video title and the user ID may be encoded in the watermark. The video title and user ID is also attached to the video in the clear. When the watermarked title and user ID matches the unsecured title and user ID, then the host considers the video authentic. In the embodiment of FIG. 1, host 108 uses hosting tool 109 to authenticate the source of the uploaded video.

In block 208, if the video is not authenticated by the host, then the host will not post the video. The user that uploaded the video may be notified of the authentication failure. Also, the host may track the number of failed authentication videos the user has attempted to upload and warn (or ban) users who attempt to upload too many inauthentic videos.

Continuing to block 210, the host designates the uploaded video as authentic using tags. These tags will mark the video as having been authenticated by the host. Embodiments of the tags include Extensible Markup Language (XML) tags, such as media Really Simple Syndication (RSS) tags, and the like. By tagging the video, when viewer 114 watches the video, the video will be identified to the viewer as authentic via the tags. Similarly, search engine 112 may read the tags and display an authenticity indicia (symbol, character, etc.) by the search results so that the search engine user knows which videos have been authenticated. In one embodiment, the tags may be tied to the video using hashing, encryption, or a combination thereof. Such mechanisms may prevent spoofing of tags that falsely indicate the video has been authenticated.

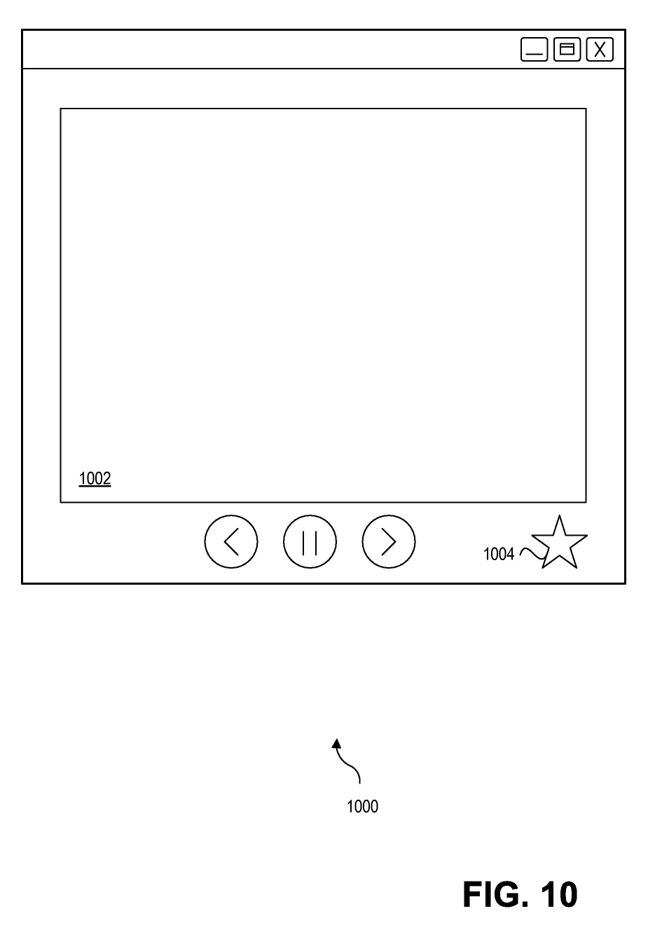

For example, referring to FIG. 10, a media player user interface 1000 in accordance with an embodiment of the invention is shown. A viewer at viewer 114 may select a video from host 108 for viewing in area 1002 of media player user interface 1000. When the video plays, such as via a web browser, the tags will indicate that the video has been authenticated by the host. When the video is authentic, an authentication indicator, such as star 1004, is displayed in media player user interface 1000. When the video has no authenticity tags, then star 1004 is not displayed or a failed authenticity symbol is shown.

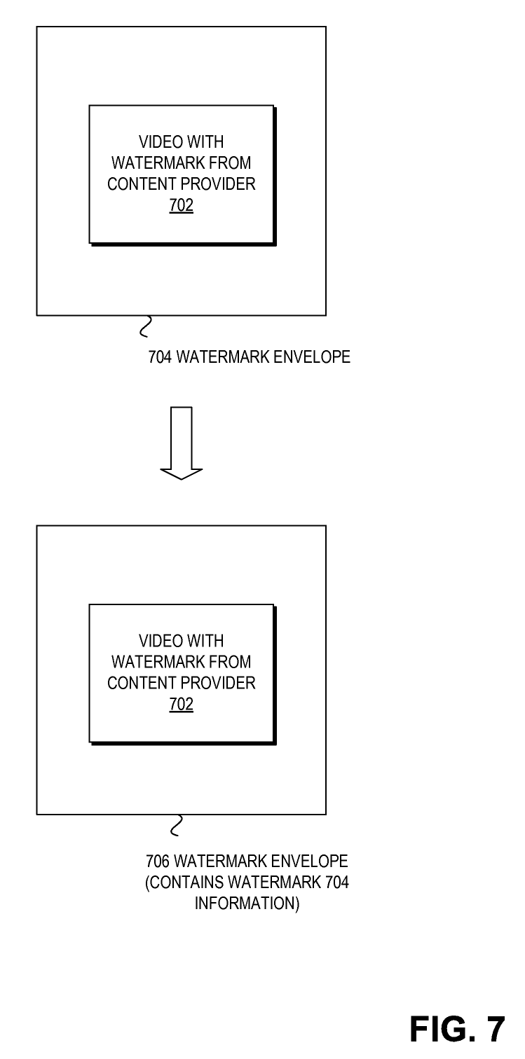

In flowchart 200, after block 210, the logic proceeds to block 212 where the host adds watermarked host-related information to the video. Host-related information may include the host Internet Protocol (IP) address, date/time of upload, IP address of content provider that the host received the upload from, and user ID of the user that uploaded the video. In one embodiment, the host may require users to create a user account with user ID to upload video. Embodiments of adding watermarked information to the video are discussed below in connection with FIGS. 7-9.

Continuing to block 214, when the video is uploaded to a new host from the current host (e.g., from host 108 to host 110), then the operations of blocks 208-214 are repeated. The host-related information added by the new host would show that the new host received the video from another host, the time/date of the upload, and so on. The host-related information may also show which user ID posted to the new host. The video may be reposted by the same user or may be reposted by a new user. Thus, as the video is passed from host to host, a tracking path is recorded in the watermark of the video.

Embodiments of the invention may track video usage in various scenarios. In one scenario, a user has downloaded another user's video from host 108 and then uploaded the video to host 110 using their own user ID. In another scenario, a user may download another user's video from host 108 and then upload the video again to host 108 using their own user ID. These video usages may or may not be allowed by the video's owner. But the video's usage in these scenarios is recorded in the video's watermark for later reconstruction of the video's movements.

Referring to FIG. 2B, tracking video 103 in accordance with an embodiment of the invention is shown. Video 103 has been posted to host 108 by user1 from content provider 106. In one embodiment, the IP address of content provider 106 is used to identify content provider 106. A host ID (e.g., host URL) is used to identify host 108 and a user ID for logging into host 108 is used to identify user1. Video 103 is then re-posted to host 110 from host 108 by user1. Video 103 is then posted again to host 130 by user2 from host 110. As shown in FIG. 2B, the trail of postings of video 103 has been appended to video 103 each time video 103 is re-posted.

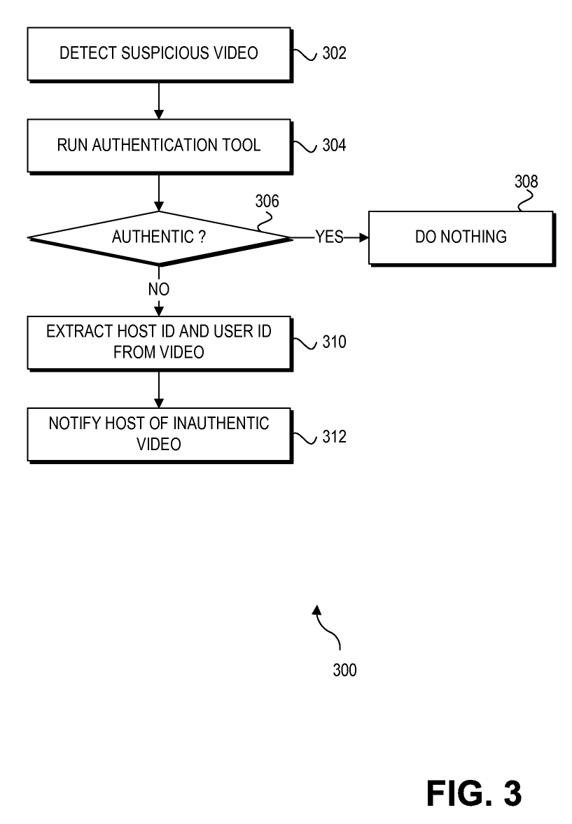

Turning to FIG. 3, a flowchart 300 shows the logic and operations of authenticating a video in accordance with an embodiment of the invention. In one embodiment, at least a portion of the logic of flowchart 300 may be conducted by a content provider, a host, a search engine, or a viewer. Starting in block 302, suspicious video is detected. In one example, a user at viewer 114 watches video and suspects the video may be an illegal copy.

Continuing to block 304, an authentication tool is run on the video to determine its authenticity. In decision block 306, if the video is determined to be authentic, then nothing is done, as shown at block 308. If the authentication tool indicates the video is inauthentic, the host identification information and user identification information is extracted from the video, as shown in block 310.

Continuing to block 312, the host where the video was viewed from is notified of the potential illegal video. The host may take this information and test the authenticity of the video. If the video is indeed inauthentic, then the video may be taken down by the host to avoid any legal problems. The host may also utilize the user ID to warn the associated user to stop posting illegal content. The host may ban the user if the user persists in posting illegal videos.

In one embodiment, a video sharing site that hosts videos may reward users who notify the video sharing site of any inauthentic videos. This encourages users to police the hosting site for potentially illegal content. The reward system may include money, a point system for users that may lead to prizes, a star rating system for users, and the like.

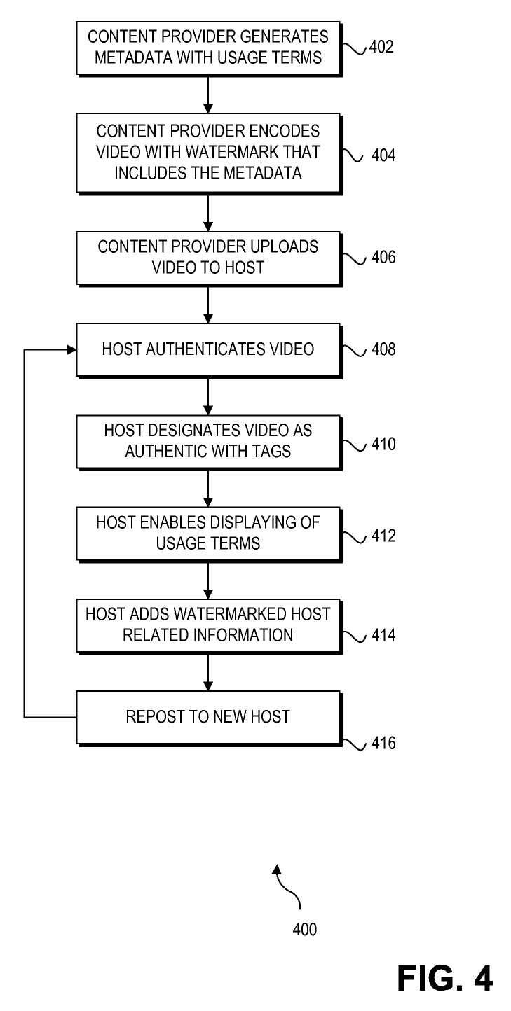

Turning to FIG. 4, a flowchart 400 shows the logic and operations of uploading video with usage terms in accordance with an embodiment of the invention. Starting in block 402, the content provider generates metadata for a video where the metadata includes usage terms for the video. In one embodiment, the usage terms may be expressed in a licensing document, such as a Creative Commons license. Various usage terms may established by the content owner. Usage examples include that use of the video must be attributed to the author, the video may be distributed/displayed but not used to make derivative works, or the video may not be used for commercial purposes.

Proceeding to block 404, the video is encoded with the watermark and the metadata. By putting the usage terms in the watermark, the usage terms travel with the video. Also, because the usage terms are embedded in the watermark, it is very difficult for someone to improperly attempt to modify the usage terms.

Continuing to block 406, the video is uploaded to the host. As discussed above, in alternative embodiments, the logic of blocks 402, 404, and 406 may be provided by a host as a service to content providers.

Next, in block 408, the host authenticates the video. The video is then tagged as authentic in block 410. Continuing to block 412, the usage terms from the watermark are extracted so that the usage terms may be displayed to viewers of the video. The host puts viewers (and downloaders) of the video on notice regarding the usage terms set by the content owner.

Proceeding to block 414, the host adds watermarked host-related information to the video. When the video is reposted to another host, as shown in block 416, then the logic of blocks 408-414 is repeated. Thus, in flowchart 400 the usage terms are distributed with the video in the watermark. Hosts that receive the video may extract the usage terms for displaying on the host site.

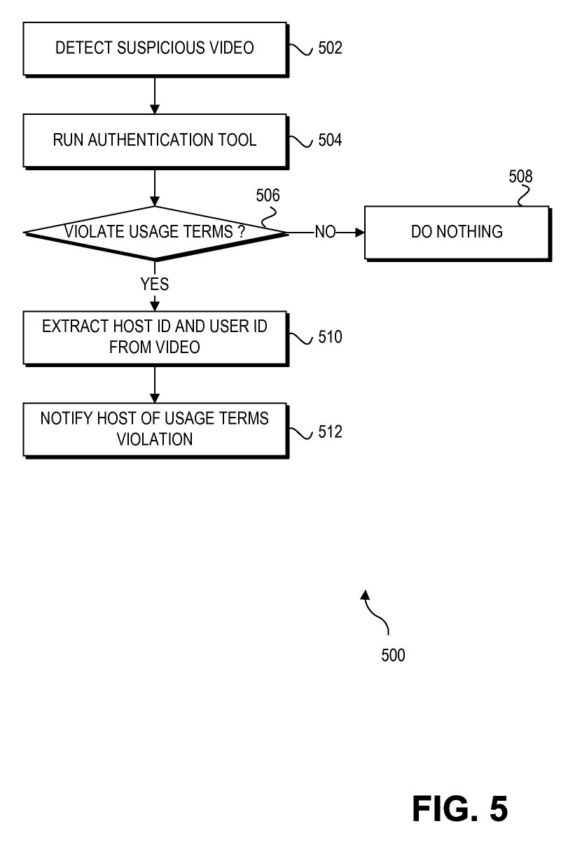

Turning to FIG. 5, a flowchart 500 shows the logic and operations of verifying complicity with usage terms of a video in accordance with an embodiment of the invention. Starting in block 502, suspicious video is detected at a host. Next, in block 504, an authentication tool is run against the video. The authentication tool determines whether the posted video violates any of the usage rules included in the watermark.

In one embodiment, a checksum, a Cyclical Redundancy Check (CRC), or other such mechanism may be used for determining usage rule violations. In one example, if a usage rule prohibits editing, than the video may include a checksum of frame count in the watermark for verification of editing. This checksum may be encrypted. In another example, a Cyclical Redundancy Check (CRC) of the video file size (or other parameter) is used for determining alterations to the video.

Continuing to block 506, if a usage term violation is detected, then nothing is done, as shown in block 508. If a usage term violation is detected, then the logic proceeds to block 510.

At block 510, the host identification information and user identification information is extracted from the video. Proceeding to block 512, the host is notified that the video posting by the user ID may violate usage terms of the video. In one embodiment, viewers of a video sharing site who report suspicious video may be rewarded.

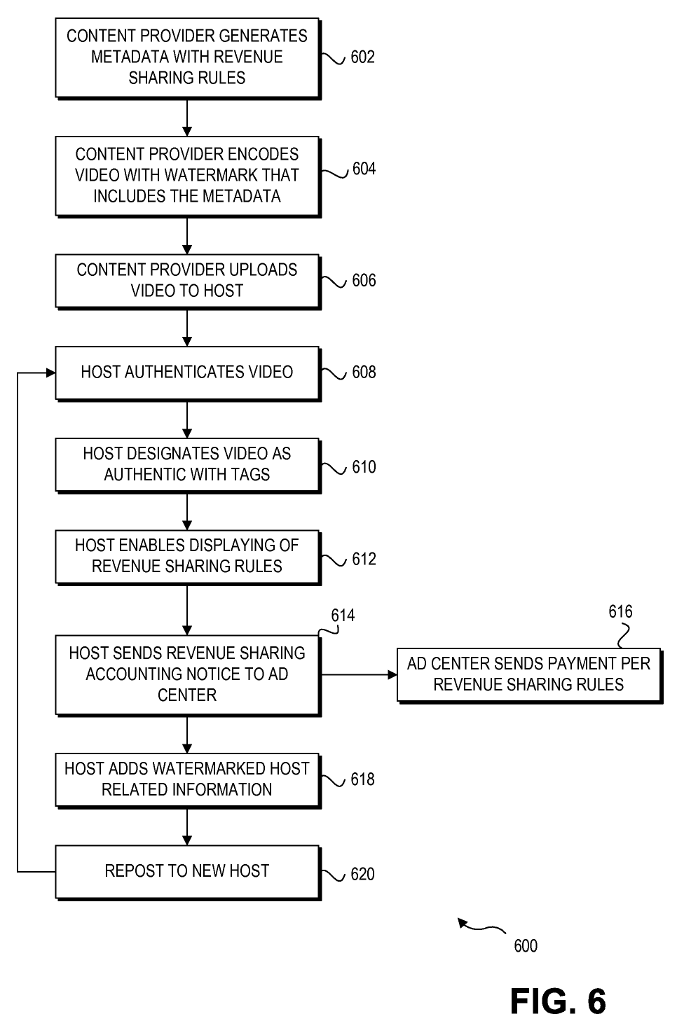

Turning to FIG. 6, a flowchart 600 shows the logic and operations of uploading video with revenue sharing rules in accordance with an embodiment of the invention. Starting in block 602, the content provider generates metadata that includes revenue sharing rules. The revenue sharing rules may indicate how much money the content owner is paid from advertisers upon viewing of the video. Example revenue sharing rules include payment for online viewing of the video with an advertisement, payment for downloads of the video, or other revenue sharing models.

Next, in block 604, the content provider encodes the video with watermarked metadata. Proceeding to block 606, the content provider uploads the video to a host. Similarly as described above, the logic of blocks 602, 604, and 606 may be conducted by the host for the content provider.

In block 608, the host authenticates the video. Next, in block 610, the host designates the video as authentic with tags. Continuing to block 612, the host enables displaying of the revenue sharing rules. Thus, when the video is requested for viewing, the host may display the revenue sharing rules to the viewer.

Proceeding to block 614, when the video is viewed, the host sends a revenue sharing accounting notice to an advertisement center. In one embodiment, the advertisement center may include one or more servers to receive periodical viewing reports from the host. In turn, the advertisement center sends payment to the content provider and/or other parties per the revenue sharing rules, as shown in block 616. In one embodiment, viewers may have to watch a commercial before viewing a video or advertising may be presented next to the video while the video is viewed. Thus, a popular video attracts many “eyeballs” and may generate revenue for advertisers, the host, and the video owner.

After block 614, the host adds watermarked host-related information to the video, as shown in block 618. Next, in block 620, when the video is reposted to a new host, the logic of blocks 608-618 is repeated.

Embodiments of the invention may be used for tracking video that ends up in a mashup. A mashup includes a video that is a combination of multiple videos and/or audio tracks. A mashup may include a combination of still photos and video and/or audio. For example, a mashup may show a map of a vacation spot along with photos and videos taken by users. Often, a user may combine videos from one or more hosts to form a mashup and then post the mashup to a host. Embodiments of the invention enable the content providers of videos in a mashup and the host of the mashup to determine if the mashup violates a usage rule of any of the videos in the mashup. Embodiments of the invention enable the content provider to ensure proper credit for the video in the mashup, such as authorship of the video or revenue in accordance with revenue sharing rules.

Embodiments of the invention allow content providers to control the viewing experience of their videos. For example, usage rules may prevent editing of a video so that advertising in the video is not edited out. Such advertisement may include an advertisement at the beginning or end of the video, product placement in the video, or product logos placed the video (e.g. the phrase “this video courtesy of Company X” appears at the bottom of the video). In another example, a movie studio may require that any postings of a movie trailer are presented in a web page with particular branding. This branding may include web page graphics, buttons (e.g., a “click here for more information” button that directs the viewer to the studio's web page), and the like. The watermarked usage rules (and ability to display usage rules to viewers) may alert a hosting site to postings of the movie trailer in violation of the trailer's usage rules.

It will also be appreciated that authentication as described herein may be distinguished from digital rights management. Traditionally, digital rights management prevents unauthorized persons from viewing and/or editing media content. Embodiments herein do not prevent viewing and/or editing of the media content, but provide authentication and usage tracking. In particular, hosts may ensure that posted videos originated from a proper source and that the posting is complicit with the video's usage terms.

Referring to FIGS. 7-9, embodiments of adding watermarked host-related information to a video are discussed. However, it will be understood that embodiments of the invention are not limited to the techniques shown in FIGS. 7-9.

Turning to FIG. 7, an embodiment of adding watermarked host-related information to the video through watermark enveloping is shown. A video 702 has been watermarked by a content provider. Video 702 may include compressed or uncompressed video. When video 702 is modified by a host, the host adds a watermark envelope 704 to video 702. Watermark envelope 704 includes host-related information added by the host. Watermark envelope 704 may be encrypted and/or protected by embedding a checksum in the video header. In this way, video 702 does not have to be decoded and re-encoded in order to modify the original watermark. The original watermark is “appended” by adding watermark 704, and this “enveloped watermark” may incorporate tamper detection methods (e.g., encryption, embedded checksum, etc.).

When video 702 (with watermark envelope 704) is uploaded to another host, this new host may update the watermark envelope having host-related information associated with the new host along the previous host path information (shown by watermark envelope 706 that has replaced watermark envelope 704). When the usage tracking of the video is to be analyzed, it may be determined if the watermark envelope was not tampered with and may thus reveal the path the video has traveled.

In one embodiment, intelligent stitching may be used to implement watermark enveloping. In intelligent stitching, one or more special intra-frames (I-frames) and/or Groups of Pictures (GOPs) that include watermarked tracking information are appended to a video. In one example, 1 to n I-frames are appended to the first frame and/or the last frame of the video. The number n is configurable and may be changed to match the encoded format and visual/auditory perceptions, most desirably the lack of perceptions of the appended frames by viewers. Every time the video is forwarded, this “envelope” is replaced with a new one containing the updated tracking information. This way, a video may contain a lot of tracking information in “the envelope” and not be perceived by human viewers/listeners as being any different from the source video. Alternatively, additional 1 to n I-frames may be appended to other frames between the first and the last frames as best suited for the specific video/audio compression format. Configurable tracking information (e.g., From: User1 ID/Host1 ID; To: User2 ID/Host2 ID) is watermarked/fingerprinted in an I-frame and/or GOP(s) and the header or trailer I-frame and/or GOPs are updated and replaced for each forward of the video. Interstitial I-frames or GOPs with tracking information may be added for resiliency if the video/audio format allows—they too may be intelligently stitched into the video/audio content in a way that may not be perceptible to the human viewer/listener. Thus, I-frames/GOPS may be attached to the video at various places (e.g., 1 to n I-frames at the first frame and 1 to n I-frames at the last frame, and possibly others inserted interstitially). These I-frames are intelligently stitched to the video, that is, the original video is not decoded/re-encoded to add the tracking I-frames. This enveloping would not be perceptible to the viewer. Tracking information may be placed in a video track, an audio track, or both (using watermarking and/or audio fingerprinting).

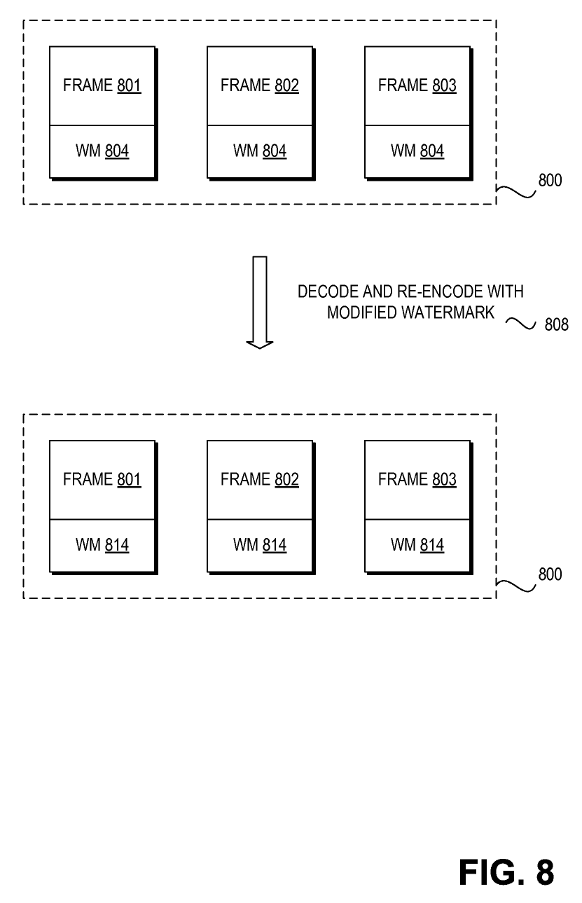

Turning to FIG. 8, another embodiment of adding watermarked host-related information to video is shown. A video 800 has frames 801, 802, and 803. Each frame has been watermarked with watermark (WM) 804. As shown at 808, video 800 is decoded, the watermarks 804 are modified with the host-related information, and then video 800 is re-encoded with the modified watermark 814. The resulting video 800 is shown wherein each frame 801-803 has modified watermark 814. As video 800 is passed from host to host, each host decodes and re-encodes video 800 with a modified watermark that includes host-related information for usage tracking of video 800.

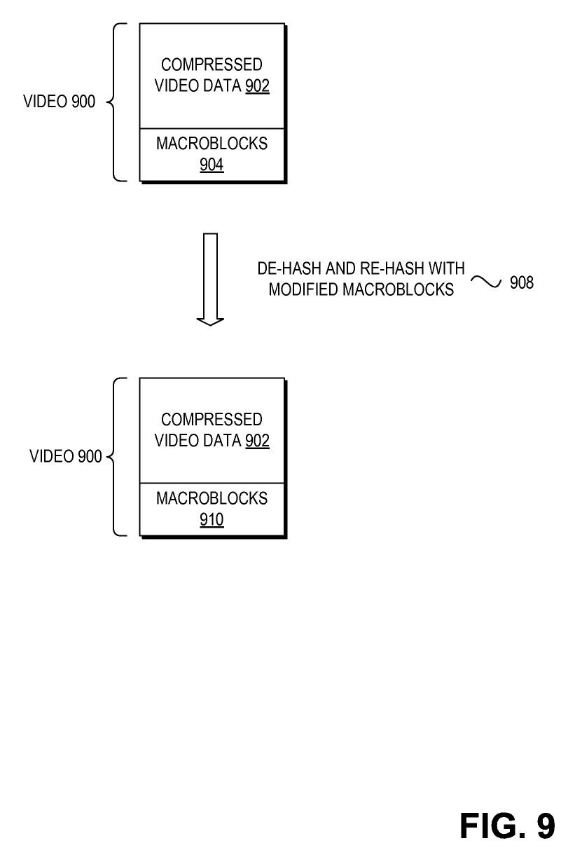

Turning to FIG. 9, another embodiment of adding watermarked host-related information to a video is shown. In the embodiment of FIG. 9, aspects of compressed video are leveraged for tracking of video. In FIG. 9, video 900 includes compressed video data 900 and associated macroblocks 904. Video 900 has been compressed by eliminating portions of frames that do not change from frame to frame. For example, if a blue sky in video 900 stays unchanged for several frames, then a single frame with the blue sky is stored and used to generate the blue sky for several frames during playback. Macroblocks 904 include motion related data that may be used to generate several frames from a single frame of video data.

In FIG. 9, macroblocks 904 may be modified to include host-related information. To add the host related information, macroblocks 904 may be de-hashed, modified with host related information, and then re-hashed as shown at 908. The resulting video 900 is shown with modified macroblocks 910.

In other embodiments, metadata in the sequence header of the video is watermarked for authentication or the Discrete Cosine Transform (DCT) of the video is watermarked with metadata for authentication. In these embodiments, the watermark is decoded and re-encoded with host related information as the video is reposted to various hosts.

Embodiments of the invention provide source authentication and usage tracking of video. A content provider may inject usage terms and revenue sharing rules into a video so that this information travels with the video. Hosts, such as video sharing sites, may use embodiments of the invention to ensure only authenticated video is posted and to manage video postings concerning video usage terms and revenue sharing. The content provider may also track the video to determine violations of the usage terms or revenue sharing rules.

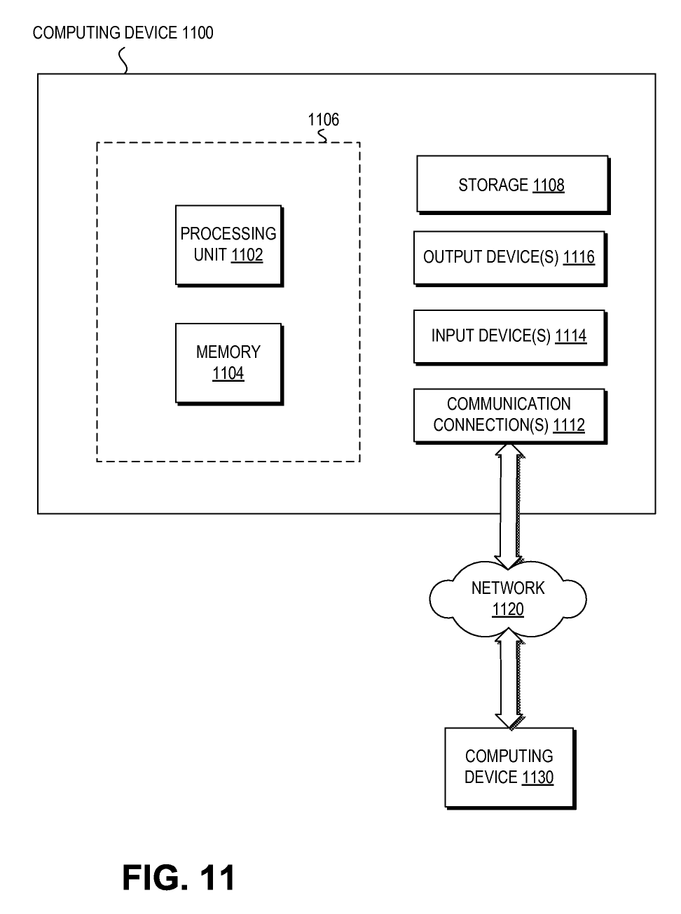

FIG. 11 and the following discussion are intended to provide a brief, general description of a suitable computing environment to implement embodiments of the invention. The operating environment of FIG. 11 is only one example of a suitable operating environment and is not intended to suggest any limitation as to the scope of use or functionality of the operating environment. Other well known computing devices, environments, and/or configurations that may be suitable for use with embodiments described herein include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments of the invention are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 shows an example of a computing device 1100 for implementing one or more embodiments of the invention. Content provider 106, host 108, host 110, search engine 112, or viewer 104 may be implemented using embodiments of computing device 1100. In one configuration, computing device 1100 includes at least one processing unit 1102 and memory 1104. Depending on the exact configuration and type of computing device, memory 1104 may be volatile (such as RAM), non-volatile (such as ROM, flash memory, etc.) or some combination of the two. This configuration is illustrated in FIG. 11 by dashed line 1106.

In other embodiments, device 1100 may include additional features and/or functionality. For example, device 1100 may also include additional storage (e.g., removable and/or non-removable) including, but not limited to, magnetic storage, optical storage, and the like. Such additional storage is illustrated in FIG. 11 by storage 1108. In one embodiment, computer readable instructions to implement embodiments of the invention may be in storage 1108. Storage 1108 may also store other computer readable instructions to implement an operating system, an application program, and the like.

The term “computer readable media” as used herein includes computer storage media. Computer storage media includes volatile and nonvolatile, removable and non-removable media implemented in any method or technology for storage of information such as computer readable instructions or other data. Memory 1104 and storage 1108 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1100. Any such computer storage media may be part of device 1100.

Device 1100 may also include communication connection(s) 1112 that allow device 1100 to communicate with other devices. Communication connection(s) 1112 may include, but is not limited to, a modem, a Network Interface Card (NIC), an integrated network interface, a radio frequency transmitter/receiver, an infrared port, a USB connection, or other interfaces for connecting computing device 1100 to other computing devices. Communication connection(s) 1112 may include a wired connection or a wireless connection. Communication connection(s) 1112 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, Near Field Communication (NFC), and other wireless media.

Device 1100 may include input device(s) 1114 such as keyboard, mouse, pen, voice input device, touch input device, infrared cameras, video input devices, and/or any other input device. Output device(s) 1116 such as one or more displays, speakers, printers, and/or any other output device may also be included in device 1100. Input device(s) 1114 and output device(s) 1116 may be connected to device 1100 via a wired connection, wireless connection, or any combination thereof. In one embodiment, an input device or an output device from another computing device may be used as input device(s) 1114 or output device(s) 1116 for computing device 1100.

Components of computing device 1100 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1100 may be interconnected by a network. For example, memory 1104 may be comprised of multiple physical memory units located in different physical locations interconnected by a network.

In the description and claims, the term “coupled” and its derivatives may be used. “Coupled” may mean that two or more elements are in contact (physically, electrically, magnetically, optically, etc.). “Coupled” may also mean two or more elements are not in contact with each other, but still cooperate or interact with each other (for example, communicatively coupled).

Those skilled in the art will realize that storage devices utilized to store computer readable instructions may be distributed across a network. For example, a computing device 1130 accessible via network 1120 may store computer readable instructions to implement one or more embodiments of the invention. Computing device 1100 may access computing device 1130 and download a part or all of the computer readable instructions for execution. Alternatively, computing device 1100 may download pieces of the computer readable instructions, as needed, or some instructions may be executed at computing device 1100 and some at computing device 1130. Those skilled in the art will also realize that all or a portion of the computer readable instructions may be carried out by a dedicated circuit, such as a Digital Signal Processor (DSP), programmable logic array, and the like.

Various operations of embodiments of the present invention are described herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of embodiments of the invention, including what is described in the Abstract, is not intended to be exhaustive or to limit the embodiments to the precise forms disclosed. While specific embodiments and examples of the invention are described herein for illustrative purposes, various equivalent modifications are possible, as those skilled in the relevant art will recognize in light of the above detailed description. The terms used in the following claims should not be construed to limit the invention to the specific embodiments disclosed in the specification. Rather, the following claims are to be construed in accordance with established doctrines of claim interpretation.

What is claimed is:

1. A method, comprising:
authenticating a video at a host using a watermark in the video, wherein the watermark includes metadata related to the video, wherein authenticating the video includes comparing metadata in the watermark to unwatermarked metadata attached to the video; and
adding watermarked host-related information to the video by the host.

2. The method of claim 1, further comprising:
generating the metadata at a content provider;
encoding the video with the watermark, wherein the watermark includes the metadata; and
sending the video to the host from the content provider.

3. The method of claim 1 wherein designating, by the host, the video as authentic with a tag, wherein the tag indicates that the video has been authenticated by the host.

4. The method of claim 1, further comprising:
determining whether the video violates video usage terms included in the watermark.

5. The method of claim 4, further comprising:
notifying the host of a usage term violation.

6. The method of claim 1, further comprising:
identifying revenue sharing rules included in the watermark.

7. The method of claim 1, further comprising:
selecting the video by a user at a computing device;
receiving notification from the host that the video is authentic; and
displaying authenticity indicia at the computing device when the video is played at the computing device.

8. The method of claim 1, further comprising:
running an authentication tool against a second video on the host; and
notifying the host by the computing device when the second video is not authenticated by the authentication tool.

9. The method of claim 1, further comprising:
displaying indicia that the video is authentic in search results that include the video, wherein the search engine reads an authentication tag associated with the video to determine the video is authentic.

10. One or more computer readable media including computer readable instructions that when executed perform the method of claim 1.

11. One or more computer readable media including computer readable instructions that when executed perform operations comprising:
receiving a video from a content provider, wherein the video includes a watermark having metadata related to the video;
authenticating the video using the watermark by comparing metadata in the watermark to unwatermarked metadata attached to the video;
designating the video as authentic; and
adding watermarked host-related information to the video.

12. The one or more computer readable media of claim 11 wherein the computer readable instructions when executed further perform operations comprising:
determining whether the video has violated video usage terms included in the watermark.

13. The one or more computer readable media of claim 11 wherein the computer readable instructions when executed further perform operations comprising:
identifying viewings of the video that trigger a revenue sharing rule encoded in the watermark of the video; and
reporting the identified viewings to an advertising center.

14. The one or more computer readable media of claim 11 wherein adding watermarked host-related information to the video includes enveloping the video with a watermark envelope that is encoded with the host-related information.

15. The one or more computer readable media of claim 11 wherein adding watermarked host-related information to the video includes modifying the watermark with the host-related information.

16. The one or more computer readable media of claim 11 wherein adding watermarked host-related information to the video includes modifying one or more macroblocks of the video to include the host-related information.

17. A system, comprising:
a content provider to encode a video with a watermark, wherein the watermark includes metadata related to the video; and
a first host coupled to the content provider via a network, the first host to receive the video, to authenticate the video using the watermark, and to add watermarked first host-related information to the video.

18. The system of claim 17, further comprising:
a second host coupled to the first host via the network, the second host to receive the video from the first host, authenticate the video using the watermark, and to add watermarked second host-related information to the video.

19. The system of claim 17, further comprising:
a search engine coupled to the first host via the network, the search engine to display indicia that the video is authentic in search results that include the video.

20. The system of claim 17, further comprising:
a viewer coupled to the first host via the network, the viewer to authentic the video using an authentication tool.
